(19) United States
(12) Patent Application Publication
(10) Pub. No.: US 2010/0066032 A1
(43) Pub. Date: Mar. 18, 2010

(54) SEAL FOR FLEXIBLE AIR DUCT

(75) Inventors: Robert F. GIRMAN, Amherst, OH (US); Audie D. GREAVES, Apple Valley, CA (US)

Correspondence Address: HAHN LOESER & PARKS, LLP, One GOJO Plaza, Suite 300, AKRON, OH, 44311-1076, US

(73) Assignee: POLYMER CONCEPTS TECHNOLOGIES, INC., Apple Valley, CA (US)

(21) Appl. No.: 12/211,581

(22) Filed: Sep. 16, 2008

(51) Int. Cl. F16J 15/32; B64D 13/02

(52) U.S. Cl. 277/522; 454/76

(57) ABSTRACT

A seal includes a main body portion having fingers that extend outward to seal against the sides of one or more flexible conduit sections. The seal embodies several features that minimize the effect of compressing the seal over extended use. In one embodiment, the seal include a tab that isolates compression forces from the fingers. Other embodiments, include a recessed hinge point between the fingers and the main body. Still other embodiments, incorporate a material that fills the region between the fingers.

### TECHNICAL FIELD

The present invention pertains to bleed air systems for turbine engines, and more particularly, to seals used in conduit conveying bleed air to various components.

### BACKGROUND OF THE INVENTION

A large percentage of aircraft today, both commercial and military, utilize turbine propulsion units powered by two or more engines. Such aircraft divert air from the engines to supply various systems on the aircraft, like for example environmental control systems, which require a continuous supply of conditioned air. In other instances, bleed air is used to cool onboard equipment. Air bled from the engines can also be used to de-ice the leading edge of the wings. Still other systems on the aircraft can use air drawn from the engines in difference ways.

To transport air bled from the engines to other areas of the aircraft, a conduit is used typically assembled from multiple tubular sections constructed from metal or other lightweight material. Air pressure in the conduit can reach up to and extend beyond 500 psig, with temperatures exceeding 1000° F. However, under typical operating conditions, nominal air pressure resides at about 50 psig and the temperature of the air is closer to 250° F. The conduit ranges in diameter from 1.00″ to 4.00″.

The bleed air conduit requires specialized seals at various points in the system. Such points are typically marked by the interface between two or more adjacent conduit sections and/or where a component is connected to a section of the conduit. In aircraft, the conduit interface or conduit coupling is characterized by its ability to flex, which is important for bleed air systems in order to compensate for misalignments of the ductwork, elongation or contraction brought about by temperature changes, and/or movements of the engine or the aircraft structure during flight.

In the current state of the art, conduit seals as shown in FIG. 3, encircle the conduit at the coupling. The intended use of seal 50 is to seal off the area between juxtaposed conduit sections. The seal 50 includes arms 51 that extend from a spine 53 contiguously formed into a ring, the configuration of which creates a concave region. The arms 51 angle away from a centerline axis Cₚₐ for engaging the respective surfaces of the conduit sections. A spring 55 is included for added biasing of the arms 51 against the conduit surfaces. When compressed or preloaded and installed into the conduit, the seal 50 inhibits the flow of pressurized air through the coupling.

During operation, vibration and movement between conduit sections contort and compress the seal 50 causing wear and fatigue. Compression force is focused on at least one particular area of the prior art seal 50, namely the spine 53. Repeated compression weakens the material and reduces the ability of the seal 50 to expand against the conduit surfaces. Even more critically, compression forces imposed on the seal 50 translate to the spring 55 and the arms 51. As the conduit sections deflect to their extremities, the spring 55 may be over-compressed and deformed thereby reducing its ability or rendering it inoperative to energize the arms 51. Spring failure often results.

Accordingly, bleed air conduit seals 50 breakdown after so many hours of use. Technicians and flight mechanics routinely inspect and replace such seals 50. The operating life of the seal 50 is generally shorter than the surrounding components, namely the various conduit sections circuitously routed throughout the craft. Considerable labor is devoted to the inspection and replacement of the seals. It would therefore be beneficial to incorporate a seal distinguished by an extended operating life cycle, and more particularly to a seal that isolates compression forces to a specific region. A primary purpose of the present invention is to provide such a device with its various attendant advantages.

### BRIEF SUMMARY

The embodiments of the present invention pertain to a device that isolates the critical components of the seal from force imposed from the surrounding structure, which may be flexible air conduit. More specifically, a cushion may be provided and installed between surfaces of the conduit that absorbs a majority of the impinging force, directing it away from the body of the seal and from the sealing projecting edges.

In one embodiment, a seal for an air conduit coupling having first and second coupling portions includes a body portion, at least a first projecting edge extending from the body portion for substantially preventing the passage of air through the associated air conduit coupling, and means for isolating compression forces between the first and second coupling portions from impinging on the at least a first projecting edge.

In one aspect of the embodiments of the subject invention, the means for isolating comprises a tab for absorbing compression forces between the first and second coupling portions thereby minimizing said compression forces from impinging on the at least a first projecting edge.

In another aspect of the embodiments of the subject invention, the seal includes a biasing device operatively disposed to bias the at least a first projecting edge into sealing engagement with the air conduit coupling, wherein the biasing device may be a spring and more specifically a leaf spring constructed from metal, polymers and/or fibrous materials.

In another aspect of the embodiments of the subject invention, the means for isolating is integrally fashioned with respect to the body portion.

In yet another aspect of the embodiments of the subject invention, the at least a first projecting edge extends from the body portion in a first direction, and wherein the means for isolating comprises a tab extending from the body portion in a second or opposite direction.

In still another aspect of the embodiments of the subject invention, the at least a first projecting edge is in resiliently deflectable connection with respect to the body portion.

In even another aspect of the embodiments of the subject invention, the seal is comprised of material containing at least 5% graphite.

In another aspect of the embodiments of the subject invention, the seal may include a depression or recess disposed between the at least a first projecting edge and the body portion defining a hinge point that isolates compression forces between the at least a first and second conduit portions from impinging on the at least a first projecting edge.

In still yet another aspect of the embodiments of the subject invention, the seal includes a material disposed between the at least a first and second projecting edges, wherein the material at least partially encapsulates the biasing device.

In another embodiment of the subject invention, a seal for an air conduit coupling having first and second coupling portions includes a body portion, at least a first projecting edge extending from the body portion for substantially preventing the passage of air through the associated air conduit coupling, a biasing device operatively connected to bias the at least a first projecting edge in sealing engagement with the air conduit coupling, and a recessed hinge point positioned between the at least a first projecting edge and the body portion for isolating compression forces between the first and second coupling portions from impinging on the biasing device.

In one aspect of the embodiments of the subject invention, the body portion and the at least a first projecting edge are contiguously formed, and a hinge point comprises a recess formed at the interface of the body portion and the at least a first projecting edge.

In another embodiment of the subject invention, a seal for an air conduit coupling having first and second coupling portions comprises a body portion, a first and at least a second projecting edge extending from the body portion for substantially preventing the passage of air through the associated air conduit coupling, a biasing device operatively connected to bias the first and the at least a second projecting edges in sealing engagement with the air conduit coupling, and a material disposed between the first and at least a second projecting edges, wherein the material at least partially encapsulates the biasing device.

In another aspect of the embodiments of the subject invention, the material disposed between the first and at least a second projecting edges is resiliently deformable for energizing the first and the at least a second projecting edges into sealing engagement with the first and second coupling portions respectively, and may include at least in part Silicon.

In another embodiment of the subject invention, an aircraft air bleed conduit includes at least a first conduit portion having a first conduit end defining an inner circumference, a second conduit portion having a second end received at least partially within the inner circumference of the first conduit end of the at least a first conduit portion, and a seal disposed between the at least a first conduit portion and the second conduit portion, wherein the seal comprises: a body portion, a first and at least a second projecting edge extending from the body portion for substantially preventing the passage of air between the at least a first and the second conduit portions, a biasing device operatively connected to bias the first and at least a second projecting edge in sealing engagement with the at least a first and the second conduit portions respectively, and a tab extending from the body portion and between the at least a first conduit portion and the second conduit portion for cushioning impact forces impinging on the biasing device.

In another aspect of the embodiments of the subject invention, the seal further comprises: a resiliently deformable material disposed between the first and the at least a second projecting edges substantially encapsulating the biasing device.

In still another aspect of the embodiments of the subject invention, the seal further comprises: at least a first hinge point disposed between either or both of the first projecting edge and the at least a second projecting and the body portion, and the position of the at least a first hinge point isolates compression forces between the at least a first and second conduit portions from impinging on the biasing device.

### BRIEF DESCRIPTION OF THE DRAWINGS

FIG. 1 is a top silhouette view of an aircraft having turbine engines that bleed air for use in other areas of the aircraft according to the embodiments of the present invention.

FIG. 2 is partial cutaway side view of bleed air conduit sections mounted within a bleed air system according to the embodiments of the present invention.

FIG. 3 is a cutaway side view of a prior art seal used in the bleed air system of an aircraft.

FIG. 4 is a cutaway side view of a seal mounted between first and second conduit sections according to the embodiments of the present invention.

FIG. 4a is a cutaway side view of a seal mounted between first and second conduit sections according to the embodiments of the present invention.

FIG. 5 is cutaway side view of a seal for use in a conduit channeling pressurized air according to the embodiments of the present invention.

FIG. 5a is perspective view of a seal for use in a conduit channeling pressurized air according to the embodiments of the present invention.

FIG. 6 is cutaway side view of another embodiment of a seal for use in a conduit channeling pressurized air according to the embodiments of the present invention.

FIG. 6a is cutaway side view of yet another embodiment of a seal for use in a conduit channeling pressurized air according to the embodiments of the present invention.

### DETAILED DESCRIPTION OF THE INVENTION

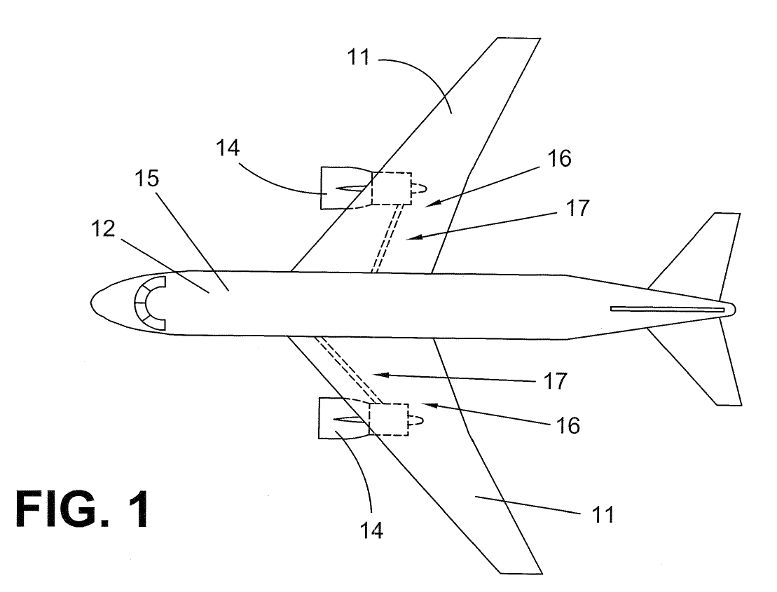

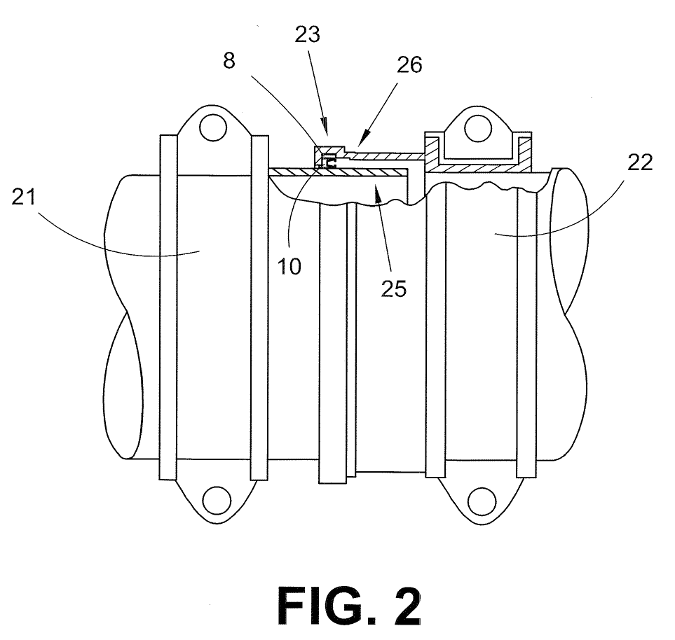

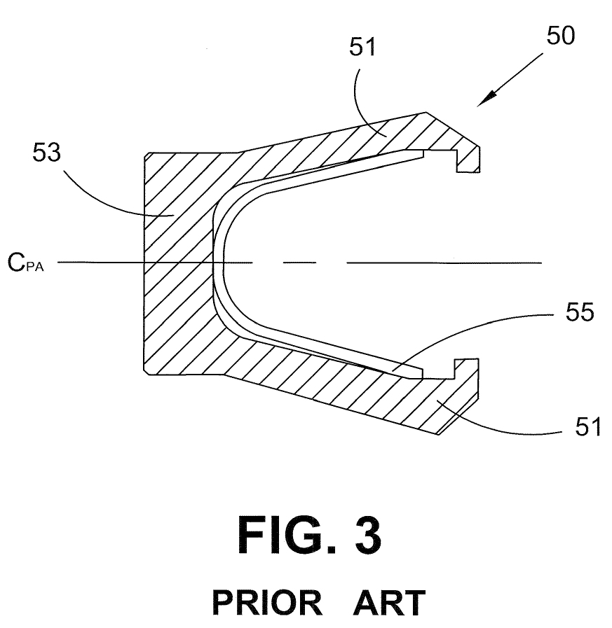

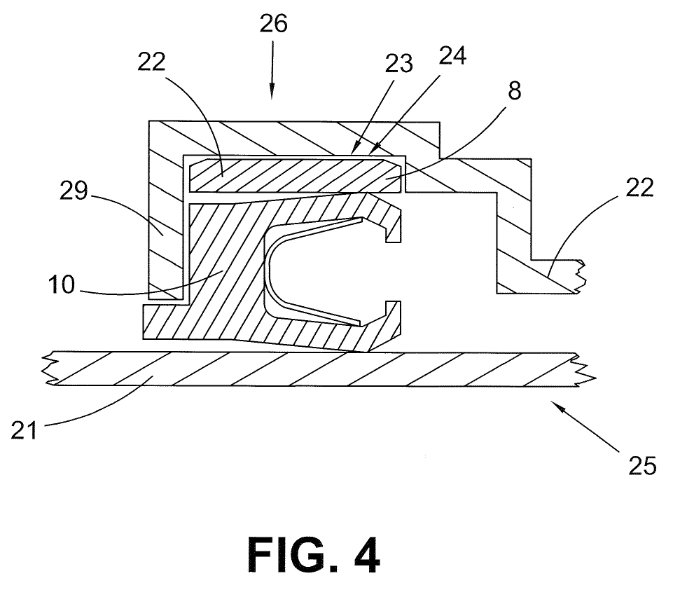

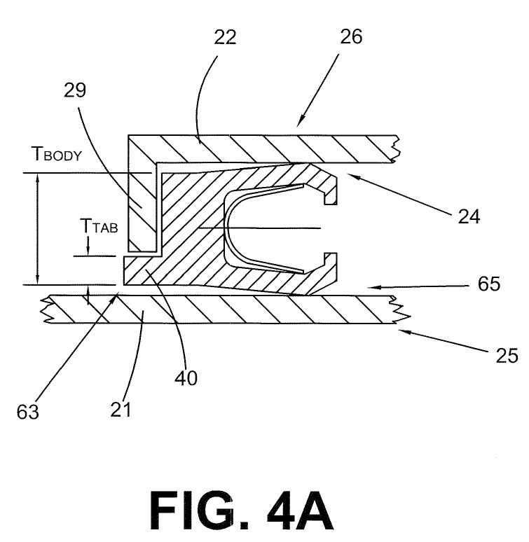

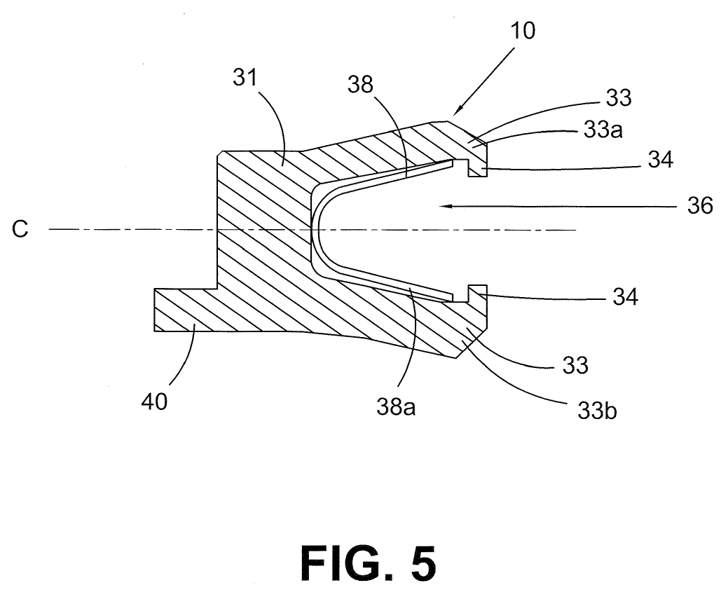

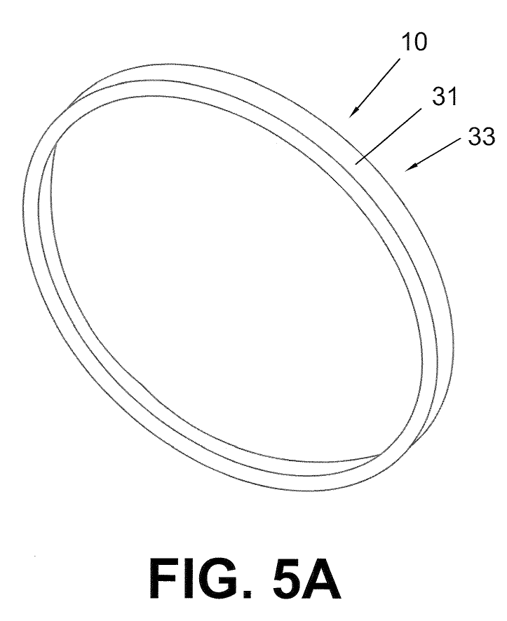

Referring now to the drawings wherein the showings are for purposes of illustrating embodiments of the invention only and not for purposes of limiting the same, FIGS. 4 and 5 shows a seal, depicted generally at 10. The seal 10 functions to substantially prevent the flow of air between components, and may be used in pumps, compressors, fuel controls, food processing equipment, and the like. In one exemplary embodiment, the seal 10 may be installed in the bleed air system 16 of a turbine engine aircraft 12, as referenced in FIGS. 1 and 2. The system 16 may incorporate one or more conduits 17 originating from within the wings 11 of the aircraft 12 and/or from the fuselage 15. The conduits 17 channel air bled from the engine 14 to other parts of the aircraft 12 in a manner similar to that described above. The seal 10 resides at the interface between components of the system 16, in this case between multiple conduit sections. More specifically, the seal 10 may be installed between the outer surface of a first conduit section 21 and one or more inner surfaces of a second conduit section 22. The seal 10 may also include a back up ring 8 designed to support the seal 10. The back up ring 8 may be fabricated from a different material or from the same material as that of the seal 10 itself, which will be discussed further in a subsequent paragraph. It will be appreciated that the concentric configuration of conduit sections presently described and the positioning of the seal 10 relative thereto are exemplary in nature. Other configurations, of the conduit sections, the conduit interface and the seal 10, will be contemplated without departing from the intended scope of coverage of the embodiments of the subject invention. It is emphasized here that the seal 10 is not limited to use only in bleed air systems. Rather, the novel aspects of the seal 10 can be used in a diversity of pressurized systems.

With reference to FIG. 2, the first conduit section 21 has a substantially cylindrically shaped end 25 that is received within the circumference of a second substantially cylindrical conduit section 22. As such, end 25 of the first conduit section 21 may be smaller than matching end 26 of the second conduit section 22. End 26 of the second conduit section 22 may be fashioned with pockets or recesses 23 contoured to receive the seal 10. Recess 23 defines an inner surface 24 of the second conduit section 22. In one embodiment, the second conduit section 22 may include a retaining wall 29 that, at least in part, holds the seal 10 in place during use. It will of course be recognized that the retaining wall 29 functions to prevent axial movement of the seal 10 with respect to the conduit section 22.

With reference again to FIG. 4, during operation of certain systems, like for example bleed air systems on airplanes, the conduit sections 21, 22 move with respect to one another. In fact, certain aviation regulations may require that one conduit section move in relation to another throughout a range of movement. For example, one conduit section 21 may deflect axially with respect to another conduit section 22. That is to say that a centerline axis of conduit section 21 may be skewed at different angles with respect to the centerline axis of conduit section 22. In some instances, the conduit sections 21, 22 may deflect up to 3°. The conduit sections 21, 22 may also reciprocate one inside the other, and additionally may rotate with respect to each other. The seal 10 functions to substantially prevent the passage of air between the conduit sections despite being compressed and contorted.

With reference now to FIGS. 5 and 5a, a novel and inventive seal 10 is shown. In one embodiment, the seal 10 comprises a body portion 31. FIG. 5a is a perspective view that shows one configuration of the body portion 31, which is annularly shaped. Fingers 33 extend from the body portion 31 in a first direction. In an exemplary, two fingers 33 are shown extending from the same side of the body portion 31. A first finger 33a angles upward with respect to a centerline axis C and a second finger 33b angles in the opposite direction, or downward. At their extremities, the fingers 33 turn inward to form a retaining ledge 34. While the figures depict the fingers 33 to be generally symmetrical about the centerline C, it is to be construed that any shape, length and angularity of the fingers 33 may be chosen as is appropriate for use with the embodiments of the subject invention. This includes symmetrical and asymmetrical configurations of the fingers 33 extending from the seal 10.

As depicted in the cross-sectional view of FIG. 5, the body portion 31 and the fingers 33 form a generally concave region 36. In one embodiment, the fingers 33 may be constructed from an elastomeric material, which will be discussed further below. In this manner, the fingers 33 are resiliently deflectable, or resiliently deformable, with respect to the body portion 31. That is to say that the material of the fingers 33 have memory wherein when deflected the fingers 33 have a tendency to return to their original position and shape. The fingers 33 therefore comprise projecting edges extending from the body portion 31 in a first direction for substantially preventing the passage of air through the region between one or more conduit sections, also termed conduit coupling. A biasing device 38 may be installed in the concave region 36 for use in energizing the fingers 33 into sealing engagement with the conduit surfaces. The biasing device 38 may incorporate a spring-like member, or spring 38a. The spring 38a may be constructed from metal or metal alloy. However, other substances may be utilized that have elastic properties suitable for energizing the fingers 33, including but not limited to polymer materials and/or fibrous materials. In a manner similar to the annular configuration of the body portion 31, the biasing device 38 may be contiguously formed around the entire circumference of the seal 10. It will be appreciated by persons of ordinary skill in the art that any manner of installing the biasing device 38 into the seal 10 may be chosen with sound engineering judgment. This may include the manual assembly of individual components, as well as over molding processes.

With reference to FIG. 5a, in one embodiment, the seal 10 may be fashioned as a unitary article having a closed circumference. More specifically, the seal 10 may be circular in configuration. However, the seal 10 may also have an elliptical shape or alternatively a polygonal shape. In fact, the circumference of the seal 10 may have any configuration as is appropriate for sealing the region between various conduit sections. Additionally, the seal 10 may be constructed from one or more polymer materials. In an exemplary manner, the seal 10 may be constructed from moldable polymers or thermoplastics, and more specifically elastomers. One such polymer may include PTFE-based compounds (polytetrafluoroethylene). Other materials may include PEEK-based compounds (polyetheretherketone). Still, any polymer material may be used that is appropriate for constructing a seal used in a pressurized system having elevated temperatures. Accordingly, the seal 10 may be injection molded. Although, any molding process may be utilized as chosen with sound engineering judgment. It is noted here that additives or filler materials may also be incorporated into the seal 10. One type of additive may include graphite. In one embodiment, as much as 10% graphite may be incorporated. Although, the amount of graphite may range from between substantially 0% to 25%. Still, any type and/or quantity of additive may be included that is suitable for use with the embodiments of the subject invention.

With reference once again to FIGS. 4 through 5a, a tab 40 may be extended from the body portion 31. By way of example, the tab 40 may extend axially away from the body portion 31. More specifically, the tab 40 may extend in the opposite direction from that of the fingers 33. The tab 40 may be positioned substantially towards one side of the body portion 31. As shown in the Figures, the tab 40 is positioned so as to extend between the outer surface of the first conduit section 21 and the retaining wall 29 of the second conduit section 22. It will be appreciated that the tab 40 may be positioned at any location respective of the body portion 31 that is conducive to filling the region between the first and second conduit sections 21, 22. It will also be understood that the particular shape of the tab 40 may follow the contour of the surfaces comprising conduit sections 21, 22 and retaining wall 29, which may include angular and/or curved surfaces. In fact, any shape of the tab 40 may be chosen as is appropriate for use with the embodiments of the subject invention.

Referring now to a cross section of the seal 10 shown in FIG. 4a, the tab 40 may have a thickness T_{tab}. As mentioned above, the tab 40 extends into the region between the outer surface of the first conduit section 21 and the end of retaining wall 29. The difference between the thickness T_{tab} and the distance between the first conduit section 21 and the retaining wall 29 define a tab gap 63. The thickness T_{tab} may be generally smaller than the nominal distance between the first conduit section 21 and the retaining wall 29. In other words, the tab 40 has a slip fit with respect to the first and second conduit sections 21, 22. Additionally, the body portion 31 has a thickness T_{body}. The body portion 31 may reside between the outer surface of the first conduit section 21 and the inner surface of the second conduit section 22, or the recess 23. A body gap 65 is defined as the difference between the thickness T_{body} of the body portion 31 and the distance between the first and second conduit sections 21, 22. The tab gap 63 may be smaller than the body gap 65. In one embodiment, the tab gap 63 may be smaller than the body gap 65 through a range extending from substantially zero to 0.100 inch. More specifically, the tab gap 63 may be smaller than the body gap 65 by substantially 0.050 inch. It is noted here that the difference in gaps 63, 65 may depend on the composition of the seal material. Accordingly, the range of differences in gaps 63, 65 may exceed 0.100 inch. Still, any difference between the gaps 63, 65 may be chosen with sound engineering judgment. Persons of ordinary skill in the art will understand that the thickness T_{tab} of the tab 40 will be sized so as not to inhibit the ability of the fingers 33 to sealingly engage the respective surfaces of the first and second conduit sections 21, 22.

In operation, the tab 40, in relation to the body portion 31, functions as a cushion to isolate compression forces imposed on the seal 10. That is to say that when, in a particular region around the circumference of the coupling, the distance between the first and second conduit section 21, 22 narrows, due to movement in the system 16, the tab 40 is compressed before the body portion 31. It may be the case that the body portion 31 is still be compressed. However, as the tab 40 is compressed further and further, resistance to the narrowing conduit sections will increase and as a result the majority of the impinging force will be imposed onto the tab 40. Accordingly, the body portion 31 and the region proximal to the fingers 33, also known as the hinge point, will be compressed fewer times and with lesser magnitude. In this manner, as the elasticity of the tab 40 deteriorates, the material of the body portion 31 remains largely unaffected by repeated compression.

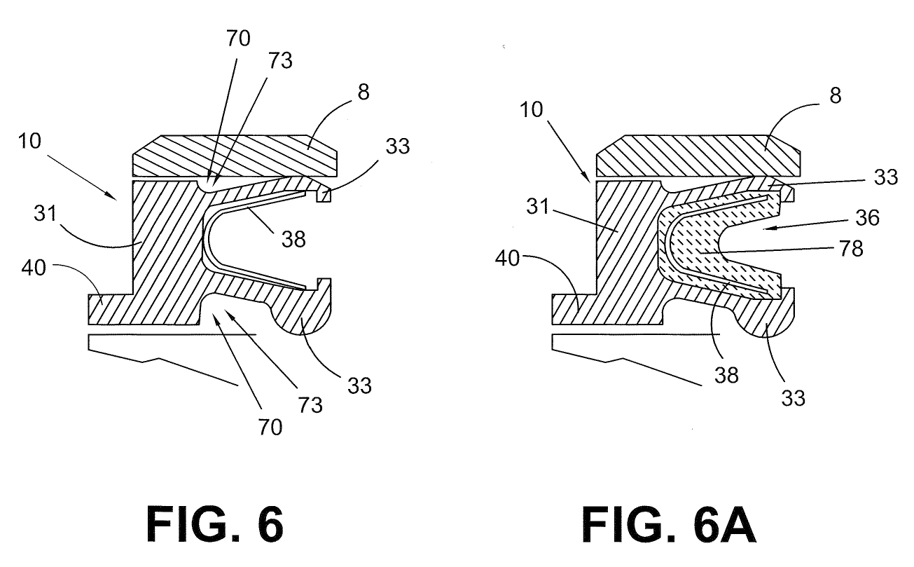

With reference now to FIG. 6, another embodiment of the subject invention will now be discussed. As noted above, force from compression of the body portion 31 indirectly translates to the fingers 33 and to the biasing device 38. Force impacts the fingers 33 most when the fingers 33 extend directly from the upper and lower planes of the body portion 31. To reduce the effect of the compression forces, the connection points of the fingers 33 with respect to the body portion may be moved respectively closer to the centerline axis C of the seal 10. Stating it another way, the hinge points 70 of the fingers 33 are moved closer to the centerline axis C of the seal 10. This effectively creates region devoid of material, i.e. a recess or trough 73, in the upper and lower surfaces of the seal 10. It is noted that any lateral position of the fingers 33 with respect to the centerline axis C of the seal 10 may be chosen as is appropriate for use with the embodiments of the subject invention. It is also noted that placement of the fingers 33 may not be symmetrical with to the centerline axis C of the seal 10. In fact, the fingers 33, either separately or together, may be positioned at any location on the side of the body portion 31.

With reference to FIG. 6a, another embodiment of the subject invention will now be discussed. As described above, the configuration of the body portion 31 and the fingers 33 defines an interior region or concave region 36, into which the biasing device 38 may be disposed. The concave region 36 may be filled with a material 78 that encapsulates the biasing device 38. In an exemplary manner, the concave region 36 may be substantially filled with an elastomeric substance. One example of an elastomeric substance may include Silicon. Alternatively, the encapsulating material 78 may have the same composition as that the body portion 31 and/or fingers 33. The encapsulating material 78 may be applied after insertion of the biasing device 38. Overmolding techniques may be used to construct the seal 10. Still, any manner of fashioning a seal 10 with encapsulating material 78 may be chosen with sound engineering judgment. The encapsulating material 78 may function as an additional energizer to the fingers 33. When compressed, the encapsulating material 78 will have a tendency to spring back further assisting to bias the fingers 33 into sealing engagement with the conduit surfaces. It is noteworthy to mention that should the biasing device 38 breakdown and fragment, the encapsulating material 78 will prevent the pieces from being introduced into the air stream.

The invention has been described herein with reference to the disclosed embodiments. Obviously, modifications and alterations will occur to others upon a reading and understanding of this specification. It is intended to include all such modifications and alterations insofar as they come within the scope of the appended claims or the equivalence thereof.

What is claimed is:

1. A seal for an air conduit coupling having first and second coupling portions, comprising:
a body portion;
at least a first projecting edge extending from the body portion for substantially preventing the passage of air through the associated air conduit coupling; and,
means for isolating compression forces between the associated first and second coupling portions from impinging on the at least a first projecting edge.

2. The seal as defined in claim 1, wherein said means for isolating comprises:
a tab for absorbing compression forces between the associated first and second coupling portions thereby isolating said compression forces from impinging on the at least a first projecting edge.

3. The seal as defined in claim 1, further comprising:
a biasing device operatively disposed to bias the at least a first projecting edge into sealing engagement with the associated air conduit coupling.

4. The seal as defined in claim 3, wherein the biasing device is a spring.

5. The seal as defined in claim 1, wherein said means for isolating is integrally fashioned with respect to the body portion.

6. The seal as defined in claim 5, wherein the at least a first projecting edge extends from the body portion in a first direction; and, wherein said means for isolating comprises a tab extending from the body portion in an opposing second direction.

7. The seal as defined in claim 1, wherein the at least a first projecting edge is in resiliently deflectable connection with respect to the body portion.

8. The seal as defined in claim 1, wherein the seal is comprised of at least 5% graphite.

9. The seal as defined in claim 3, wherein the biasing device is a leaf spring extended between the at least a first projecting edge and a second projecting edge.

10. The seal as defined in claim 9, further comprising:
a material disposed between the at least a first and second projecting edges, wherein the material at least partially encapsulates the biasing device.

11. The seal as defined in claim 1, further comprising:
a recess disposed between the at least a first projecting edge and the body portion thereby defining a hinge point that isolates compression forces between the associated at least a first and second coupling portions from impinging on the at least a first projecting edge.

12. A seal for an air conduit coupling having first and second coupling portions, comprising:
a body portion;
at least a first projecting edge extending from the body portion for substantially preventing the passage of air through the associated air conduit coupling;
a biasing device operatively connected to bias the at least a first projecting edge in sealing engagement with the associated air conduit coupling; and,
a hinge point positioned between the at least a first projecting edge and the body portion for isolating compression forces between the first and second coupling portions from impinging on the biasing device.

13. The seal as defined in claim 12, wherein the body portion and the at least a first projecting edge are contiguously formed; and,
wherein the hinge point comprises a recess formed at the interface of the body portion and the at least a first projecting edge.

14. A seal for an air conduit coupling having first and second coupling portions, comprising:
a body portion;
a first and at least a second projecting edge extending from the body portion for substantially preventing the passage of air through the associated air conduit coupling;
a biasing device operatively connected to bias the first and the at least a second projecting edges into sealing engagement with the associated air conduit coupling; and,
a material disposed between the first and the at least a second projecting edges, wherein the material at least partially encapsulates the biasing device.

15. The seal as defined in claim 14, wherein the material is resiliently deformable for energizing the first and the at least a second projecting edges into sealing engagement with the first and second coupling portions respectively.

16. The seal as defined in claim 15, wherein the material includes Silicon.

17. An aircraft air bleed conduit, comprising:
at least a first conduit portion having a first conduit end defining an inner circumference;
a second conduit portion having a second end received at least partially within the inner circumference of the first conduit end of the at least a first conduit portion; and,
a seal disposed between the at least a first conduit portion and the second conduit portion, wherein the seal comprises:
a body portion;
a first and at least a second projecting edge extending from the body portion for substantially preventing the passage of air between the at least a first and the second conduit portions;
a biasing device operatively connected to bias the first and at least a second projecting edge in sealing engagement with the at least a first and the second conduit portions respectively; and,
a tab extending from the body portion and between the at least a first conduit portion and the second conduit portion for cushioning impact forces impinging on the biasing device.

18. The aircraft air bleed conduit as defined in claim 17, wherein the seal further comprises:
a resiliently deformable material disposed between the first and the at least a second projecting edges substantially encapsulating the biasing device.

19. The aircraft air bleed conduit as defined in claim 17, wherein the seal further comprises:
at least a first recess disposed between either or both of the first projecting edge and the at least a second projecting and the body portion; and,
wherein the position of the at least a first recess operatively isolates compression forces between the at least a first and second conduit portions from impinging on the biasing device.

20. The aircraft air bleed conduit as defined in claim 17, wherein the seal further comprises:
a polymer material disposed between the first and the at least a second projecting edges substantially encapsulating the biasing device; and,
at least a first recess disposed between either or both of the first projecting edge and the at least a second projecting and the body portion respectively, wherein the at least a first recess defines a hinge point that isolates compression forces between the at least a first and second conduit portions from impinging on the biasing device.
